(19) United States
(12) Patent Application Publication
(10) Pub. No.: US 2025/0157774 A1
(43) Pub. Date: May 15, 2025

(54) CHIP FUSE WITH FLOATING LEADS

(71) Applicant: Littelfuse, Inc., Chicago, IL (US)

(72) Inventors: Maria Lily Espenilla Rosios, Batangas (PH); Caryl Nicole Aleta, Batangas (PH)

(73) Assignee: Littelfuse, Inc., Chicago, IL (US)

(21) Appl. No.: 18/930,138

(22) Filed: Oct. 29, 2024

Related U.S. Application Data
(60) Provisional application No. 63/598,312, filed on Nov. 13, 2023.

(51) Int. Cl. H01H 85/055; H01H 85/02; H01H 85/143

(52) U.S. Cl. CPC H01H 85/055; H01H 85/0241; H01H 85/143

(57) ABSTRACT

A chip fuse including a fuse body with an electrically insulating floating lead support layer, a metallic first floating lead and a metallic second floating lead disposed on the floating lead support layer and spaced apart to define a gap therebetween, an electrically insulating fuse support layer disposed adjacent, and parallel to, the floating lead support layer, and an electrically conductive fuse layer disposed on the fuse support layer, the fuse layer including a first terminal portion and a second terminal portion connected by a fusible portion. The chip fuse further includes an electrically conductive first end termination and an electrically conductive second end termination disposed on opposing ends of the fuse body, wherein the first end termination is electrically connected to the first terminal portion and the first floating lead and wherein the second end termination is electrically connected to the second terminal portion and the second floating lead.

### CROSS-REFERENCE TO CORRESPONDING APPLICATIONS

The present application claims the benefit of priority under 35 U.S.C. § 119 to U.S. Provisional Application Ser. No. 63/598,312, titled “CHIP FUSE WITH FLOATING LEADS” and filed Nov. 13, 2023, the disclosure of which is incorporated herein by reference in its entirety.

### FIELD OF THE DISCLOSURE

This disclosure relates generally to the field of circuit protection devices and relates more particularly to a chip fuse having embedded, floating leads for dissipating heat and increasing breaking capacity.

### BACKGROUND OF THE DISCLOSURE

Chip fuses (also commonly referred to as “solid-body” fuses) typically include a fusible element sandwiched between two or more layers of dielectric material (e.g., ceramic) that form a fuse body. The fusible element extends between electrically conductive terminals located on opposing ends of the fuse body. When the fusible element melts during an overcurrent condition, it is sometimes possible for an electrical arc to propagate between the separated portions of the fusible element. The electrical arc may generate significant heat which, in some cases, may rupture the dielectric layers of the chip fuse, creating a fire hazard and potentially damaging surrounding components. The likelihood of rupture is generally proportional to the severity of the overcurrent condition. The maximum current that a chip fuse can arrest without rupturing is referred to as the chip fuse's “breaking capacity.” It is generally desirable to maximize the breaking capacity of a chip fuse without significantly increasing the size or form factor of the chip fuse.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A chip fuse including a fuse body defined by an electrically insulating floating lead support layer, a metallic first floating lead and a metallic second floating lead disposed on the floating lead support layer in a spaced apart arrangement to define a gap between the first floating lead and the second floating lead, an electrically insulating fuse support layer disposed adjacent, and parallel to, the floating lead support layer, and an electrically conductive fuse layer disposed on the fuse support layer, the fuse layer comprising a first terminal portion and a second terminal portion connected by a fusible portion. The chip fuse further includes an electrically conductive first end termination and an electrically conductive second end termination disposed on opposing ends of the fuse body, wherein the first end termination is electrically connected to the first terminal portion and the first floating lead and wherein the second end termination is electrically connected to the second terminal portion and the second floating lead.

A chip fuse including a fuse body defined by an electrically insulating first floating lead support layer a metallic first floating lead and a metallic second floating lead disposed on the floating lead support layer in a spaced apart arrangement to define a gap between the first floating lead and the second floating lead, an electrically insulating second floating lead support layer disposed on the first floating lead and the second floating lead, a metallic third floating lead and a metallic fourth floating lead disposed on the second floating lead support layer in a spaced apart arrangement to define a gap between the third floating lead and the fourth floating lead, at least one electrically insulating barrier layer disposed on the third floating lead and the fourth floating lead, an electrically insulating fuse support layer disposed on the at least one barrier layer, an electrically conductive fuse layer disposed on the fuse support layer, the fuse layer comprising a first terminal portion and a second terminal portion connected by a fusible portion, and an electrically insulating protective layer disposed on the fuse layer. The chip fuse further includes an electrically conductive first end termination and an electrically conductive second end termination disposed on opposing ends of the fuse body, wherein the first end termination is electrically connected to the first terminal portion, the first floating lead, and the third floating lead, and wherein the second end termination is electrically connected to the second terminal portion, the second floating lead, and the fourth floating lead.

### BRIEF DESCRIPTION OF THE DRAWINGS

By way of example, various embodiments of the disclosed system will now be described, with reference to the accompanying drawings, wherein:

FIG. 1A is a perspective view illustrating a chip fuse in accordance with an embodiment of the present disclosure;

FIG. 1B is an exploded view illustrating the chip fuse shown in FIG. 1A;

FIGS. 2-6 are a series of top views and perspective views illustrating various floating lead configurations in accordance with embodiments of the present disclosure.

### DETAILED DESCRIPTION

A chip fuse in accordance with the present disclosure will now be described more fully with reference to the accompanying drawings, in which preferred embodiments of the chip fuse are presented. It will be understood, however, that the chip fuse described below may be embodied in many different forms and should not be construed as being limited to the embodiments set forth herein. Rather, these embodiments are provided so that this disclosure will convey certain exemplary aspects of the chip fuse to those skilled in the art.

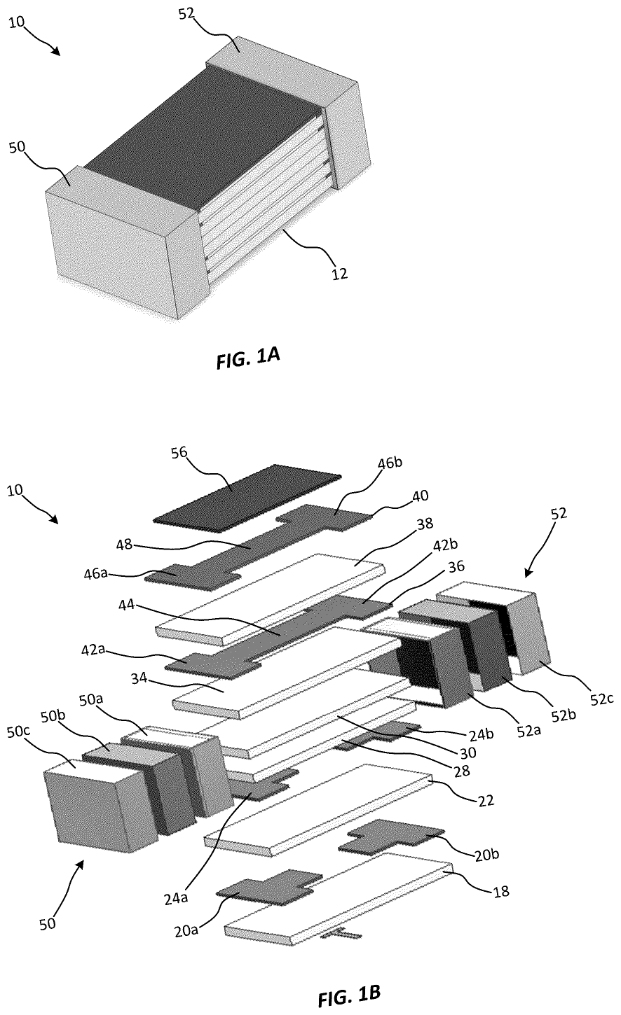

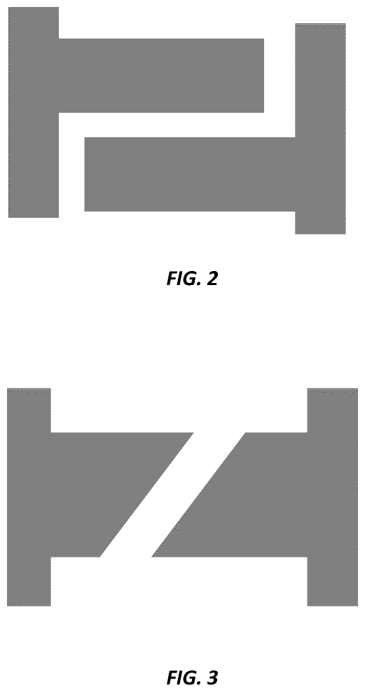

Referring to FIGS. 1A and 1B, a perspective view and an exploded view illustrating a chip fuse 10 (hereinafter “the fuse 10”) in accordance with a non-limiting embodiment of the present disclosure are shown. The fuse 10 may include a laminate fuse body 12 having a plurality of electrically insulating and electrically conductive layers disposed in a stacked arrangement. The plurality of layers may include a first floating lead support layer 18, first and second floating leads 20a, 20b disposed on the first floating lead support layer 18 in a spaced-apart arrangement to define a gap therebetween, a second floating lead support layer 22 disposed on the first and second floating leads 20a, 20b, third and fourth floating leads 24a, 24b disposed on the second floating lead support layer 22 in a spaced-apart arrangement to define a gap therebetween, a plurality of barrier layers 28, 30 disposed on the third and fourth floating leads 24a, 24b, a first fuse support layer 34 disposed atop the uppermost barrier layer 30, a first fuse layer 36 disposed atop the first fuse support layer 34, a second fuse support layer 38 disposed atop the first fuse layer 36, and a second fuse layer 40 disposed atop the second fuse support layer 38.

The first floating lead support layer 18, second floating lead support layer 22, barrier layers 28, 30, first fuse support layer 34, and second fuse support layer 38 may be formed of an electrically insulating material, including, but not limited to, FR-4, glass, ceramic (e.g., low temperature co-fired ceramic), etc. In various embodiments, the aforementioned electrically insulating layers may be formed of ceramic tape (“green tape”). The present disclosure is not limited in this regard. The first and second floating leads 20a, 20b, third and fourth floating leads 24a, 24b, first fuse layer 36, and second fuse layer 40 may be formed of a metal with good electrical and thermal conductivity, including, but not limited to, copper, tin, silver, various alloys, etc. In various embodiments, the aforementioned electrically conductive layers may be formed of the same metal or different metals without limitation.

The first fuse layer 36 may include first and second terminal portions 42a, 42b connected by a fusible portion 44. Similarly, the second fuse layer 40 may include first and second terminal portions 46a, 46b connected by a fusible portion 48. In various embodiments, the fusible portions 44, 48 may be thinned, narrowed, or otherwise mechanically weakened relative to the respective first and second terminal portions 42a, 42b and 46a, 46b, and may be adapted to melt and separate upon the occurrence of a predetermined fault condition in the fuse 10, such as an overcurrent condition in which an amount of current exceeding a predefined maximum current (i.e., a “rating” of the fuse 10) flows through the fusible portions 44, 48. As will be appreciated by those of ordinary skill in the art, the size, shape, configuration, and material of the fusible portions 44, 48 may all contribute to the rating of the fuse 10.

The fuse 10 may further include electrically conductive first and second end terminations 50, 52 disposed on opposing longitudinal ends of the fuse body 12. The first end termination 50 may be electrically connected to the first terminal portion 42a of the first fuse layer 36 and to the first terminal portion 46a of the second fuse layer 40, as well as to the first and third floating leads 20a, 24a. Similarly, the second end termination 52 may be electrically connected to the second terminal portion 42b of the first fuse layer 36 and to the second terminal portion 46b of the second fuse layer 40, as well as to the second and fourth floating leads 20b, 24b. The first and second end terminations 50, 52 may be formed of several layers of electrically conductive material that may be applied to the fuse body 12 using a succession of dipping and plating processes. For example, the first and second end terminations 50, 52 may include respective first layers 50a, 52a that may be formed by dipping the opposing ends of the fuse body 12 into a metal paste (e.g., silver paste), whereafter the paste is dried and sintered. The first and second end terminations 50, 52 may further include respective second layers 50b, 52b, applied over the first layers 50a, 52a, that are formed of another metal (e.g., nickel) and that are applied using an electroplating process. The first and second end terminations 50, 52 may further include respective third layers 50c, 52c, applied over the second layers 50b, 52b, that are formed of another metal (e.g., tin) and that are applied using a plating process. The present disclosure is not limited in this regard.

The fuse 10 may further include a protective layer 56 formed of epoxy, glass, or other insulating materials disposed on the second fuse layer 40. The protective layer 56 may shield the second fuse layer 40 from external contaminants and may prevent electrical shorting between the second fuse layer 40 and surrounding electrical components. In various embodiments, the protective layer 56 may be substantially identical to the above-described support layers and barriers layers (e.g., identical to the second fuse support layer 38) and may be formed of an electrically insulating material such as FR-4, glass, ceramic (e.g., low temperature co-fired ceramic), etc. The present disclosure is not limited in this regard.

While the fuse 10 has been described above as having a first floating lead support layer 18 with first and second floating leads 20a, 20b disposed thereon and a second floating lead support layer 22 with third and fourth floating leads 24a, 24b disposed thereon, alternative embodiments of the present disclosure are contemplated wherein the fuse 10 is provided with a greater or fewer number of floating lead support layers and associated pairs of floating leads. For example, in various embodiments the fuse 10 may have only a single floating lead support layer with a single pair of floating leads disposed thereon. Similarly, while the fuse 10 has been described above as having a total of two fuse layers 36, 40, alternative embodiments of the present disclosure are contemplated wherein the fuse 10 is provided with a greater or fewer number of fuse layers. For example, in various embodiments the fuse 10 may have only a single fuse support layer with a single fuse layer disposed thereon. Still further, in various embodiments the vertical arrangement of the various layers of the fuse body 12 may be varied relative to the embodiment described above and shown in FIG. 1B. The present disclosure is not limited in this regard.

During normal operation of the fuse 10, electrical current may flow from the first end termination 50, through the first and second fuse layers 36, 40, to the second end termination 52, or vice versa. If the fuse 10 is operated at high amperages (e.g., 20 A or more), the current may generate significant heat in the fuse body 12. Additionally, upon the occurrence of an overcurrent condition in the fuse 10, the fusible portions 44, 48 of the first and second fuse layers 36, 40 may melt and separate, and electrical arcs may propagate between the separated portions of the fusible portions 44, 48. These electrical arcs may also generate significant heat in the fuse body 12, even if the fuse 10 carries a relatively lower amperage (e.g., less than 20 A) during normal operation. If heat in the fuse 10 is left unmitigated, it could cause damage to the fuse body 12 and/or to surrounding components. Advantageously, the first and second floating leads 20a, 20b and the third and fourth floating leads 24a, 24b may act as heat sinks that absorb heat in the fuse 10 and facilitate dissipation of the heat through the first and second end terminations 50, 52, thereby attenuating surface temperature rise in the fuse body 12, both during normal operation and during an overcurrent condition. The risk of combustion and/or rupture of the fuse body 12, and the risk of damage to surrounding components, are thereby mitigated. Additionally, the first and second floating leads 20a, 20b and the third and fourth floating leads 24a, 24b, which are formed of metal, may provide the fuse body 12 with structural reinforcement that strengthens the fuse body 12 and further mitigates the risk of rupture/breakage. Thus, the fuse 10 may exhibit a lower operating temperature and superior breaking capacity relative to chip fuses having a similar form factor.

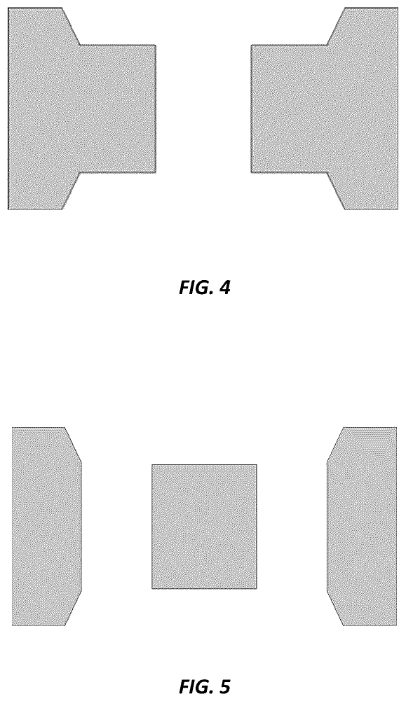

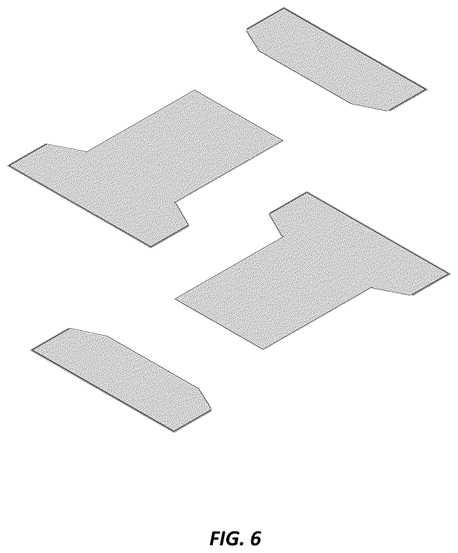

The first and second floating leads 20a, 20b and the third and fourth floating leads 24a, 24b are shown in FIG. 1B as being generally T-shaped. This is not intended to be limiting, and it is contemplated that the first and second floating leads 20a, 20b and the third and fourth floating leads 24a, 24b may be implemented with a variety of alternative shapes without departing from the scope of the present disclosure. Non-limiting examples of such alternative shapes are provided in FIGS. 2-6. Referring specifically to FIG. 6, an alternative embodiment of the first and second floating leads 20a, 20b and the third and fourth floating leads 24a, 24b is shown, wherein the first and second floating leads 20a, 20b are asymmetrical (e.g., the first floating lead 20a is elongated relative to the second floating lead 20a, 20b), and wherein the third and fourth floating leads 24a, 24b are a mirror image of the first and second floating leads 20a, 20b.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A chip fuse comprising:
a fuse body comprising:
an electrically insulating floating lead support layer;
a metallic first floating lead and a metallic second floating lead disposed on the floating lead support layer in a spaced apart arrangement to define a gap between the first floating lead and the second floating lead;
an electrically insulating fuse support layer disposed adjacent, and parallel to, the floating lead support layer; and
an electrically conductive fuse layer disposed on the fuse support layer, the fuse layer comprising a first terminal portion and a second terminal portion connected by a fusible portion; and
an electrically conductive first end termination and an electrically conductive second end termination disposed on opposing ends of the fuse body, wherein the first end termination is electrically connected to the first terminal portion and the first floating lead and wherein the second end termination is electrically connected to the second terminal portion and the second floating lead.

2. The chip fuse of claim 1, further comprising at least one electrically insulating barrier layer disposed atop the first floating lead and the second floating lead in a parallel relationship with the floating lead support layer.

3. The chip fuse of claim 1, wherein the floating lead support layer and the fuse support layer are formed of ceramic tape.

4. The chip fuse of claim 1, wherein the floating lead support layer is a first floating lead support layer and wherein the fuse body further comprises a second floating lead support layer disposed adjacent, and parallel to, the first floating lead support layer and having a third floating lead and a fourth floating lead disposed thereon in a spaced apart relationship to define a gap between the third floating lead and the fourth floating lead.

5. The chip fuse of claim 4, wherein the first floating lead and the second floating lead are asymmetrical, and wherein the third floating lead and the fourth floating are a mirror image of the first floating lead and the second floating lead.

6. The chip fuse of claim 1, wherein the fuse support layer is a first fuse support layer and the fuse layer is a first fuse layer, and wherein the fuse body further comprises a second fuse support layer disposed adjacent, and parallel to, the first fuse support layer and having a second fuse layer disposed thereon.

7. The chip fuse of claim 1, further comprising a protective layer disposed on the fuse layer.

8. The chip fuse of claim 7, wherein the protective layer is formed of one of FR-4 and ceramic.

9. The chip fuse of claim 7, wherein the protective layer is formed of glass.

10. The chip fuse of claim 1, wherein the first end termination and the second end termination are each formed of a plurality of layers of electrically conductive material.

11. A chip fuse comprising:
a fuse body comprising:
an electrically insulating first floating lead support layer;
a metallic first floating lead and a metallic second floating lead disposed on the floating lead support layer in a spaced apart arrangement to define a gap between the first floating lead and the second floating lead;
an electrically insulating second floating lead support layer disposed on the first floating lead and the second floating lead;
a metallic third floating lead and a metallic fourth floating lead disposed on the second floating lead support layer in a spaced apart arrangement to define a gap between the third floating lead and the fourth floating lead;
at least one electrically insulating barrier layer disposed on the third floating lead and the fourth floating lead;
an electrically insulating fuse support layer disposed on the at least one barrier layer;
an electrically conductive fuse layer disposed on the fuse support layer, the fuse layer comprising a first terminal portion and a second terminal portion connected by a fusible portion; and
an electrically insulating protective layer disposed on the fuse layer; and
an electrically conductive first end termination and an electrically conductive second end termination disposed on opposing ends of the fuse body, wherein the first end termination is electrically connected to the first terminal portion, the first floating lead, and the third floating lead, and wherein the second end termination is electrically connected to the second terminal portion, the second floating lead, and the fourth floating lead.

12. The chip fuse of claim 11, wherein the first floating lead support layer, the second floating lead support layer, the barrier layer, and the fuse support layer are formed of ceramic tape.

13. The chip fuse of claim 11, wherein the first floating lead and the second floating lead are asymmetrical, and wherein the third floating lead and the fourth floating are a mirror image of the first floating lead and the second floating lead.

14. The chip fuse of claim 11, wherein the fuse support layer is a first fuse support layer and the fuse layer is a first fuse layer, and wherein the fuse body further comprises a second fuse support layer disposed adjacent, and parallel to, the first fuse support layer and having a second fuse layer disposed thereon.

15. The chip fuse of claim 11, wherein the protective layer is formed of one of FR-4 and ceramic.

16. The chip fuse of claim 11, wherein the protective layer is formed of glass.

17. The chip fuse of claim 11, wherein the first end termination and the second end termination are each formed of a plurality of layers of electrically conductive material.
